(19) United States
(12) Patent Application Publication
(10) Pub. No.: US 2022/0068178 A1
(43) Pub. Date: Mar. 3, 2022

(54) SYSTEMS AND METHODS FOR CONTROLLING AN ELECTRONIC DISPLAY

(71) Applicant: Frame My TV, Methuen, MA (US)

(72) Inventors: Randal Davis, Methuen, MA (US); Kevin Hancock, Methuen, MA (US)

(21) Appl. No.: 17/011,357

(22) Filed: Sep. 3, 2020

(51) Int. Cl. G09G 3/20

(52) U.S. Cl. CPC G09G 3/20; G09G 2354/00; G09G 2360/144

(57) ABSTRACT

The disclosure relates to control systems for relaying signals to an electronic device, such as a smart controller for sensing one or more ambient conditions within a space and controlling the operation of an electronic display in response to the ambient condition.

### TECHNICAL FIELD

Generally, the disclosure relates to control systems for relaying signals to an electronic device. In particular, the disclosure relates to a smart controller for sensing one or more ambient conditions within a space and controlling the operation of an electronic display, such as a television in response to the ambient condition.

### BACKGROUND

Mounting flat screen televisions or other electronic display on a wall has become fairly commonplace. However, people have become interested in disguising the display or otherwise blending the display into a room's décor. One way this has been accomplished is by the incorporation of a framing assembly disposed about a perimeter of the display. Unfortunately, in some cases, the frame assembly may block or otherwise interfere with the exchange of signals between the display and, for example, an ambient environment or a remote control. Accordingly, there is a need for a system for interacting with a disguised display.

### SUMMARY

Generally, the disclosed control systems may be incorporated in a frame assembly or attached to a display so as to allow the systems to sense the presence of a person or other change in ambient condition and control the display accordingly. In addition, the systems are capable relaying signals between the display and associated equipment, such as a remote control.

In one aspect, the disclosure relates to a smart control system for an electronic display. The system includes a first sensor configured to detect motion, a second sensor configured to detect ambient light, a controller in electrical communication with the first and second sensors and configured to generate at least one output relative to a sensed condition, and a relay in electrical communication with the controller and configured to transmit at least one output signal. The first sensor may be configured to motion within a defined area, such as a room. The controller (e.g., a processor and related electronic components) may generate the output relative to light, motion, etc.

In various embodiments, the first sensor may be selected from the group consisting of a camera, a passive infrared sensor, a microwave sensor, an ultrasonic sensor, a vibration sensor, an area reflective type sensor, a tomographic sensor, a gesture detector, or combinations thereof. The second sensor may be selected from the group consisting of a photo-diode, a photo-conductor, a photo-resistor, a photovoltaic device, a photo-transistor, a charge-coupled device, or combinations thereof. The system may further include a light-emitting diode (LED) in electrical communication with the relay, where the LED is configured to output a series of light pulses in response to a signal received by at least one of the first or second sensors. In some embodiments, the LED includes an array of LEDs configured to be in optical communication with one or more sensors on the electronic display. The LED or array of LEDs may be in wireless communication with the relay and configured for remote mounting relative to the relay. Alternative sources of output signals are contemplated and considered within the scope of the disclosure.

Additionally, the system may include a housing, where the first and second sensors, the controller, and the relay may be disposed within the housing. The housing may also include a mounting mechanism to attach at least a portion of the system to at least one of the electronic display or a frame adjacent to the electronic display. For example, the system may be substantially disposed behind a frame assembly to be virtually invisible to a user, but for an antenna or sensor extending outwardly or downwardly from the frame assembly. In additional embodiments, the LED or the array of LEDs is disposed within a housing (e.g., a second housing) including a mounting mechanism configured to adjustably attach the array to at least one of the electronic display or a frame adjacent to the electronic display so as to make the LED or array adjustable relative to the one or more sensors on the electronic display.

In yet other embodiments, the system includes a housing having a front face and a rear face, wherein the first and second sensors, the controller, and the relay are disposed within the housing and the at least one output signal is transmitted from the rear face of the housing and the system is coupled to the electronic display via the front face. The system may include a LED in electrical communication with the controller and disposed on the rear face of the housing, where the LED is configured to be optical communication with one or more sensors on the electronic display and to output a series of light pulses in response to a signal received by at least one of the first and second sensors. The system may also include a power source, such as an electrical cord, battery, etc. The system may also include an adjustment mechanism configured to adjust a sensitivity of at least one of the first sensor or the second sensor and/or an adjustment mechanism configured to adjust an intensity level of the at least one output. In various embodiments, the electronic display may be a television, a computer monitor, a tablet, etc. The system (e.g., the housing) may include a ventilation system.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and can exist in various combinations and permutations.

Numerous other aspects, features and benefits of the present disclosure may be made apparent from the following detailed description taken together with the drawing figures. The pharmaceutical compositions can include nucleic acid constructs described herein along with other components, or ingredients depending on desired prevention and treatment goals. It should be further understood that both the foregoing general description and the following detailed description are exemplary and explanatory and are intended to provide further explanation of the disclosure as claimed.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure and are not intended as a definition of the limits of the disclosure. For purposes of clarity, not every component may be labeled in every drawing. In the following description, various embodiments of the present disclosure are described with reference to the following drawings, in which:

FIG. 1 is a pictorial representation of an electronic display incorporating a smart controller in accordance with one or more embodiments of the disclosure;

FIG. 2 is a schematic, plan view of a smart controller in accordance with one or more embodiments of the disclosure;

FIG. 3 is a schematic rear view of the smart controller of FIG. 2 in accordance with one or more embodiments of the disclosure;

FIG. 4 is a schematic perspective view of a portion of an alternative smart controller in accordance with one or more embodiments of the disclosure;

FIG. 5 is a schematic perspective view of another portion of an alternative smart controller in accordance with one or more embodiments of the disclosure; and

FIG. 6 is an electrical schematic for a smart controller in accordance with one or more embodiments of the disclosure.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated here, and additional applications of the principles of the disclosures as illustrated here, which would occur to one skilled in the relevant art and having possession of this disclosure, are to be considered within the scope of the disclosure. For example, the systems described herein can be used to control essentially any type of electronic screen, as opposed to only flat screen televisions.

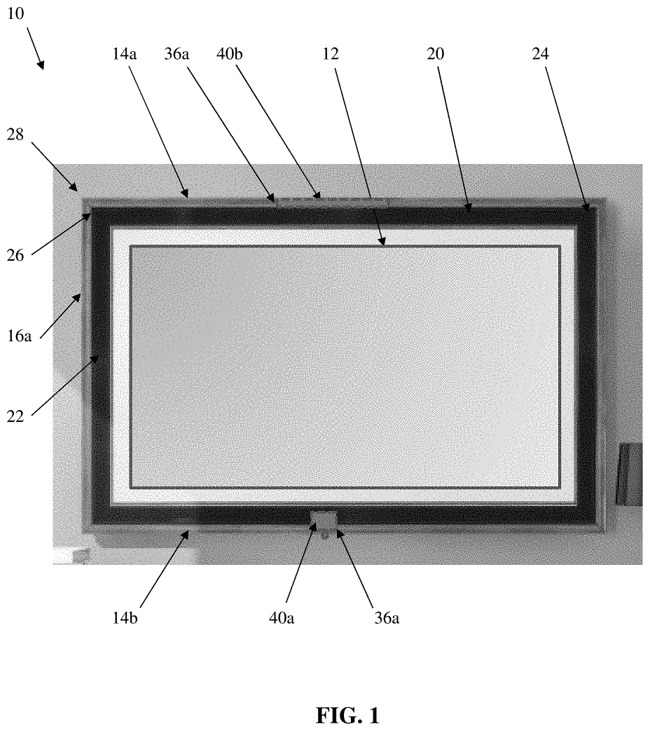

FIG. 1 depicts an embodiment of a framing system 10 that can be used to frame a television or other electronic screen 12. As shown, the system 10 includes two elongate horizontal members 14a, 14b, two elongate vertical members 16a, 16b, and a plurality of fastening mechanisms 18. Each of the elongate members 14, 16 has a body portion 20, 22 and opposing ends 24, 26. Typically, the opposing ends 24, 26 will form first and second halves of a mitered joint 28. Each of the elongate members 14, 16 will also have a front face 30 and an opposite back face 32. As shown, the elongate members have generally rectangular shapes; however, the shapes and profiles of the elongate members can vary to suit a particular design. In various embodiments, the elongate members 14, 16 can be made of a wood, a polymer, a metal or combinations thereof.

FIG. 1 further depicts the incorporation of a smart controller 140 into the frame assembly 10 and/or on the display 12 for enabling communication between the display 12 and a remote control and/or an ambient condition. In some embodiments, one of the elongate members 14, 16 may include one or more receptacles or other type of opening, access means, or mounting structure 36 that can be used to house or mount the smart controllers described herein. As shown in FIG. 1, there are two mounting structures 36a, 36b, each incorporated for receiving a portion of one embodiment of a smart controller. In some embodiments, the mounting structure is a mounting pad including threaded holes and/or brackets for mounting the smart controller 40 thereto, as known to a person of skill in the art. Generally, the smart controller 40 is attached to a back face of the frame assembly to be virtually invisible to a user. For example, a first portion of the controller 40a may be mounted to the frame such that only a small portion (e.g., a sensor or antenna) of the controller 40a extends beyond the frame assembly 10. Additionally, a second portion of the controller 40b may be mounted completely behind the frame assembly in an adjustable manner so that the output signals may be properly aligned with any sensors on the display.

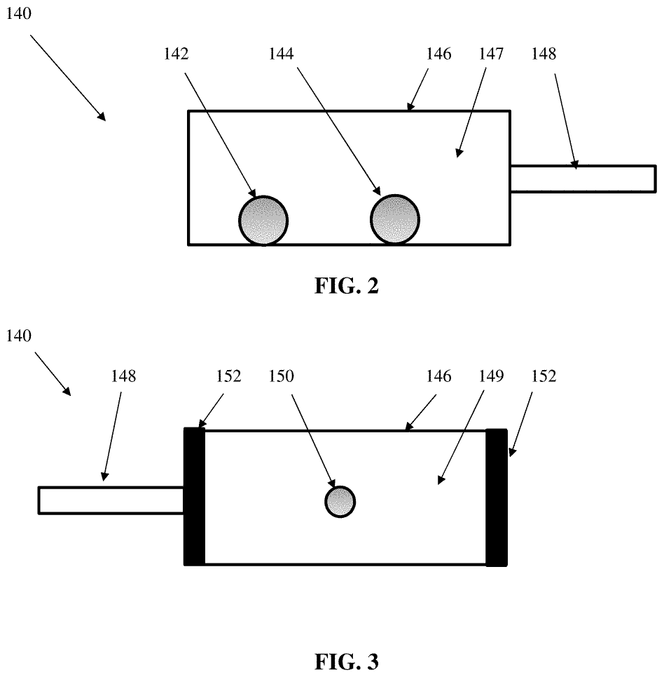

FIGS. 2 and 3 depict one embodiment of a system 140 for controlling an electronic display (e.g., 12 in FIG. 1), i.e., a smart controller. As generally shown, the system/controller 140 includes a housing 146 in which two or more sensors 142, 144 are located and configured to sense multiple ambient conditions proximate the display. The sensors are located on a front face of the housing 146, which may be partially visible to the environment. One sensor 142 may be a motion sensor, such as a 3.2 GHz microwave Doppler radar module, such as model no. RCWL-0516, while the other sensor 144 can be a light sensor, such as model no. NSL-6112-ND as available form Advanced Photonics. Additional sensors can be included to suit a particular application, for example, multiple displays, the ability to sense motion at different locations, and/or to relay signals from associated equipment, such as a remote control. In some embodiments, the sensors 142, 144 may be mounted substantially or completely within the housing and proximate a window or similar structure to facilitate communication with the surrounding area. The housing 146 may also include mounting means 152 that may include, for example, one or more brackets, clearance holes for mechanical fasteners, or an adhesive surface. In some cases, the housing 146 is sized and shaped to securely engage a portion of the framing system 10, such as an interference fit with the receptacle 36 or mating hardware on a back surface of the frame 10.

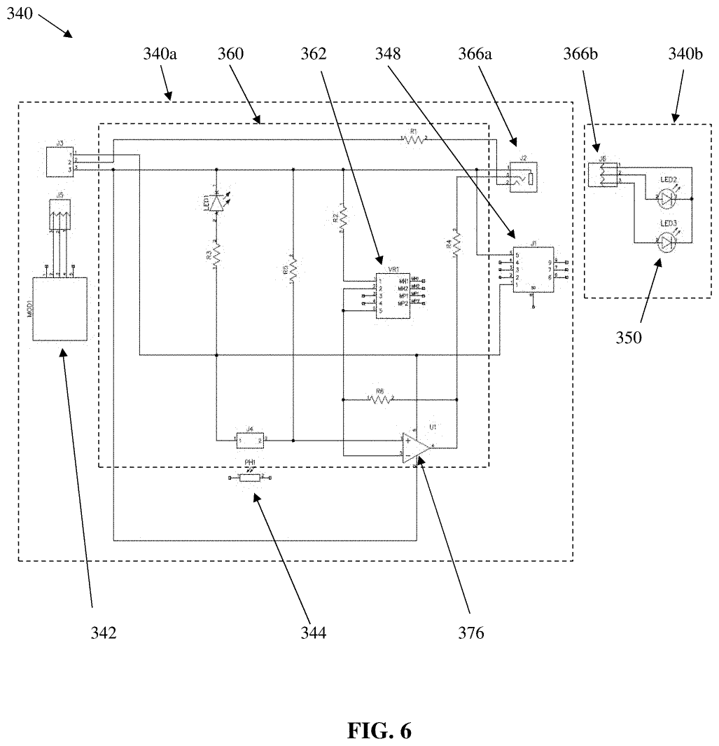

As shown in FIG. 2, the sensors 142, 144 are generally disposed relative to a front face 147 of the housing 146. As shown in FIG. 3, the system/controller 140 further includes one or more outputs 150, such as a light emitting diode (LED) or an array of LEDs 150, disposed on a rear face 149 of the housing 146. Generally, the output(s) 150 are configured and positioned so as to relay one or more signals relative to a sensed condition to the display. In some embodiments, the controller 140 includes an internal controller (e.g., 360 in FIG. 6), such as a processor or other micro-electronic circuitry disposed within the housing 146 and in electrical communication with the sensors 142, 144 and other electrical components, such as a power source 148, miscellaneous indicators (e.g., a power light), miscellaneous connectors, and a relay for outputting one or more signals relative to a condition sensed by the sensors 142, 144. The power source 148 may include an electrical cord as shown or a battery or the like disposed within the housing 146.

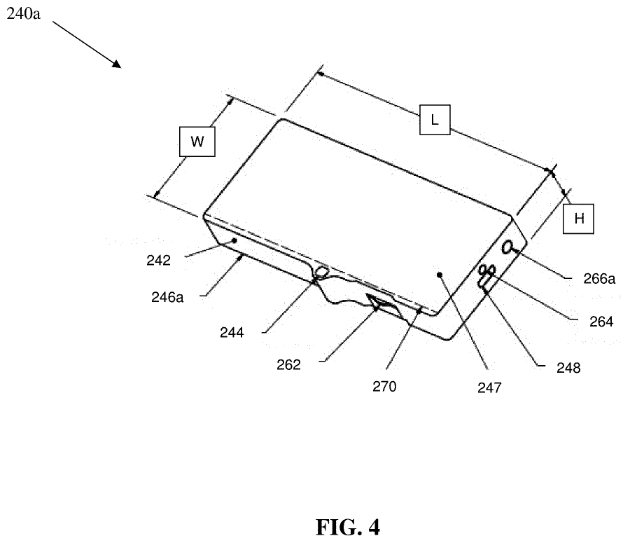

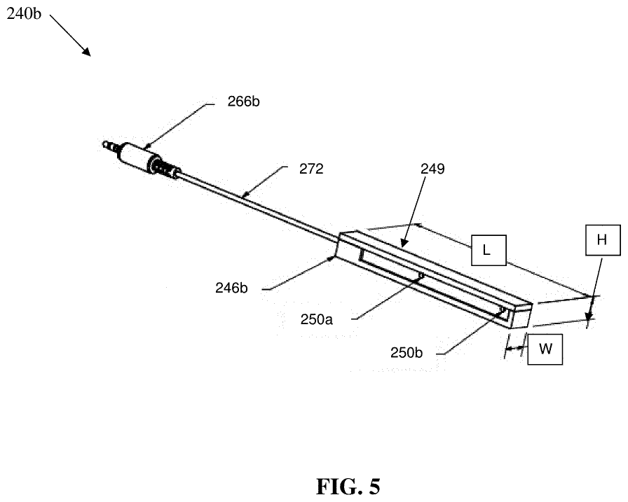

FIGS. 2 and 3 depict a controller 140 where all or substantially all of the components are disposed within a single housing 146; however, an embodiment where the controller 140 is embodied in two housing portions is depicted in FIGS. 4 and 5. FIGS. 4 and 5 depict an embodiment of a smart controller 240, where the controller is embodied in two portions, a first portion 240a (FIG. 4) for sensing and processing the sensed conditions and a second portion 240b (FIG. 5) for outputting signals to the display.

As shown in FIG. 4, the first portion of the controller 240a includes a housing 246a in which two or more sensors 242, 244 are located and configured to sense multiple ambient conditions proximate the display. As previously discussed, the first sensor 242 may be a motion detector and the second sensor 244 may be a light sensor. The housing 246a may be sized and shaped to be discretely mounted behind a portion of the frame assembly, where a portion 270 may extend beyond the frame assembly for detection purposes (e.g., so that the ambient light sensor and/or antenna have unimpeded views of the area). The controller portion 240a may be attached as previously described via a front face 247 of the housing 246a. The dimensions (W×L×H) of the housing 246a will vary to suit a particular application, such as spacing necessary for housing the components and/or conforming to a shape and size of frame assembly.

The controller portion 240a also includes a sensitivity adjustment (e.g., a dial) 262 for controlling the sensitivity levels of the sensors 242, 244. Disposed on a side face of the housing 246a are a power indicator light 264, a power input 248a (e.g., a micro-USB port), and a peripheral input 266a (e.g., a 2.5 mm stereo input) for interfacing with the second portion of the controller 240b and/or other peripheral equipment.

FIG. 5 depicts an output light bar as the second portion of the smart controller 240b. As shown, the second portion 240b includes a housing 246b, in which one or more outputs 250a, 250b are disposed, along with any necessary circuitry. In some embodiments, the first output 250a is an ambient light repeater and the second output 250b is a motion detector signal. The dimensions (W×L×H) of the housing 246b will also vary to suit a particular application, such as spacing necessary for housing the components and/or conforming to a shape and size of the frame assembly. The housing 246b may be attached to the frame assembly via its back face 249, and in any manner as disclosed herein, so that the outputs 250a, 250b are in communication with any necessary sensors on the display. In some embodiments, the housing 246b may be attached to the frame assembly via a sliding (or otherwise adjustable) bracket, so as to adjust the alignment of the outputs 250a, 250b with the display sensors. The second controller portion 240b also includes a 2.5 mm stereo jack 266b for interfacing with the first portion of the controller 240a and/or other peripheral equipment. The jack 266b may be coupled to the second controller portion 240b via a cable 272, as known to a person of skill in the art. While certain types of connectors are disclosed herein, other types of electrical connections are contemplated and considered within the scope of the invention.

FIG. 6 depicts a simplified electrical schematic for one or more embodiments of a smart controller 340. The smart controller is depicted as having two portions 340a, 340b; however, all of the components may be housed in a single module/housing. As shown in FIG. 6, the first module 340a includes a motion sensor 342, a light sensor 344, and a controller 360 (e.g., processor and associated electronics). The controller 360 includes an adjustment mechanism 362, such as a 20 VDC, 10 K ohm potentiometer, that may be configured to adjust a sensitivity of the sensors 342, 344 and/or intensity level of the outputs 350. The module 340a may also include one or more connectors 348, 366a for interfacing with a power source and the second module 340b. The controller 360 also includes a relay 376 for transmitting one or more output signals to the output devices 350 (e.g., via connectors 366a, 366b to the second module 340b). The second module 340b includes a mating connector 366b for interfacing with the first module 340a and a plurality of outputs 150, such as single LEDs or arrays of LEDs.

The various electrical components that make up the controller 340 may be coupled together via a circuit board and/or appropriately sized wiring as generally known to a person of skill in the art.

In general, the word “controller” or “processor” are used herein in their broad and ordinary sense and refer, for example, to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts.

Software instructions may be embedded in firmware, such as an EPROM. It will be further appreciated that hardware modules may be comprised of connected logic units, such as gates and flip-flops, and/or may be comprised of programmable units, such as programmable gate arrays, application specific circuits, or hardware processors. The modules described herein are preferably implemented as software modules, but may be represented in hardware or firmware.

Generally, the controllers/processors described herein refer to logical modules that may be combined with other modules or divided into sub-modules despite their physical organization or storage.

The various logical blocks, modules, data structures, and processes referred to herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices, for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware or firmware, in a software module executed by a hardware processor, or in a combination of the two. For example, each of the processes described above may also be embodied in, and fully automated by, software modules executed by one or more machines such as computers or computer processors. A module may reside in a non-transitory computer-readable storage medium such as RAM memory, flash memory, ROM memory, EPROM memory, EEPROM memory, registers, a hard disk, a removable disk, an optical storage disk, memory capable of storing firmware, or any other form of computer readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC. Hardware components may communicate with other components via wired or wireless communication networks such as, e.g., the Internet, a wide area network, a local area network, or some other type of network.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives.

Furthermore, those skilled in the art should appreciate that the parameters and configurations described herein are exemplary and that actual parameters and/or configurations will depend on the specific application in which the systems and techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto; the disclosure may be practiced other than as specifically described.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

What is claimed is:

1. A smart control system for an electronic display, the system comprising:
a first sensor configured to detect motion;
a second sensor configured to detect ambient light;
a controller in electrical communication with the first and second sensors and configured to generate at least one output relative to a sensed condition; and
a relay in electrical communication with the controller and configured to transmit at least one output signal.

2. The system of claim 1, wherein the first sensor is selected from the group consisting of a camera, a passive infrared sensor, a microwave sensor, an ultrasonic sensor, a vibration sensor, an area reflective type sensor, a tomographic sensor, a gesture detector, or combinations thereof.

3. The system of claim 1, wherein the second sensor is selected from the group consisting of a photo-diode, a photo-conductor, a photo-resistor, a photovoltaic device, a photo-transistor, a charge-coupled device, or combinations thereof.

4. The system of claim 1 further comprising a light-emitting diode (LED) in electrical communication with the relay, wherein the LED is configured to output a series of light pulses in response to a signal received by at least one of the first or second sensors.

5. The system of claim 1 further comprising a housing, wherein the first and second sensors, the controller, and the relay are disposed within the housing.

6. The system of claim 5, wherein the housing further comprises a mounting mechanism to attach at least a portion of the system to at least one of the electronic display or a frame adjacent to the electronic display.

7. The system of claim 4, wherein the LED comprises an array of LEDs configured to be in optical communication with one or more sensors on the electronic display.

8. The system of claim 7, wherein the array of LEDs is in wireless communication with the relay and configured for remote mounting relative to the relay.

9. The system of claim 7, wherein the array of LEDs is disposed within a housing comprising a mounting mechanism configured to adjustably attach the array to at least one of the electronic display or a frame adjacent to the electronic display to adjust the array relative to the one or more sensors on the electronic display.

10. The system of claim 1 further comprising a housing having a front face and a rear face, wherein the first and second sensors, the controller, and the relay are disposed within the housing and the at least one output signal is transmitted from the rear face of the housing and the system is coupled to the electronic display via the front face.

11. The system of claim 10 further comprising a LED in electrical communication with the controller and disposed on the rear face of the housing, wherein the LED is configured to be optical communication with one or more sensors on the electronic display and to output a series of light pulses in response to a signal received by at least one of the first and second sensors.

12. The system of claim 1 further comprising a power source.

13. The system of claim 1, wherein the system further comprises an adjustment mechanism configured to adjust a sensitivity of at least one of the first sensor or the second sensor.

14. The system of claim 1, wherein the system further comprises an adjustment mechanism configured to adjust an intensity level of the at least one output.

15. The system of claim 1, wherein the electronic display comprises at least one of a television, a computer monitor, or a tablet.

16. The system of claim 1 further comprising a ventilation system.
